(19) United States
(12) Patent Application Publication
(10) Pub. No.: US 2016/0305732 A1
(43) Pub. Date: Oct. 20, 2016

(54) ARRANGEMENT FOR RECOIL SIMULATION AND WEAPON TRAINING

(71) Applicant: SAAB AB, Linköping (SE)

(72) Inventors: Martin Jandl, Slavkov u Brna (CZ); Jindrich Trbola, Rousinov u Vyskova (CZ)

(73) Assignee: SAAB AB, Linköping (SE)

(21) Appl. No.: 15/100,438

(22) PCT Filed: Nov. 29, 2013
(86) PCT No.: PCT/SE2013/051422

§ 371 Date: May 31, 2016

(51) Int. Cl. F41A 33/06; G09B 9/00

(52) U.S. Cl. CPC F41A 33/06; G09B 9/003

(57) ABSTRACT

A weapon including a barrel or barrel replica. A recoil generator arrangement is configured to generate a recoil or hammer cocking. The recoil generator arrangement includes a cylinder, a piston movably arranged in the cylinder and an oblong element arranged on the piston. The cylinder is removably attachable on a front end of the weapon so that the oblong element extends from the front end through the barrel or barrel replica to an element inside the weapon and moves the element when the piston is moved.

### TECHNICAL FIELD

The present invention generally relates to the field of simulation and weapon training. In particular, the invention relates to a device for generating recoil or hammer cocking in a weapon comprising a barrel or barrel replica.

### BACKGROUND ART

Firearms are among others used by police and military. Often the firearms are not used very often and there is therefore a need for weapon training in order to keep skills up to date. Weapon training has often been accomplished with live ammunition at targets in specific firing range areas. One disadvantage of this procedure is the cost of the ammunition used.

Another disadvantage is that firing ranges require space, are not easily accessible and can often only be used in daylight. Further, live ammunition requires that hearing protectors are worn.

Today there are also simulated weapons provided with laser beams. The laser beams are detected by targets. One disadvantage with simulated weapons are that they do not provide all the desired features when weapon training. That is the simulated weapon does not recoil. Weapon training with simulated weapons are thus not realistic.

It is therefore conceivable to assume that a market incentive exists to remove the mentioned limitations one way or the other. However, despite this incentive, and despite prior attempts to overcome problems relating to weapon training there is still a need for a solution for weapon training, which solution overcome or at least mitigates one of the above problems.

### SUMMARY OF THE INVENTION

It is therefore an object of the present invention to alleviate the above limitations. This object is attained by a recoil generator arrangement configured to generate a recoil or hammer cocking in a weapon comprising a barrel or barrel replica. The recoil generator arrangement comprises a cylinder, a piston movably arranged in the cylinder and an oblong element arranged on the piston. The cylinder is attachable on a front end of the weapon so that the oblong element extends from the front end through the barrel or barrel replica to an element inside the weapon, and moves the element when the piston is moved.

Thus, an object of the present invention is achieved by moving the element fast and so that the element is stopped by an inside part of the weapon. The fast moving element that is stopped by an inside part of the weapon creates a recoil or hammer cocking of the weapon. The recoil or hammer cocking is thus created in a similar way as when the weapon is fired with sharp ammunition.

One of the main advantages of the present invention is the solution to the previously mentioned shortcomings. The invention eliminates the problem of using simulated weapon or weapons without ammunition that does not recoil. Thus weapon training with the recoil generator arrangement according to the present invention becomes more realistic than weapon training with simulated weapons, or with weapons without ammunition.

### BRIEF DESCRIPTION OF THE DRAWINGS

Objects, advantages and effects as well as features of the invention will be more readily understood from the following detailed description of exemplary embodiments of the invention when read together with the accompanying drawings, in which:

FIG. 1 schematically illustrates an arrangement for generating recoil or hammer cocking according to an exemplary embodiment of the present invention.

FIG. 2 schematically illustrates an arrangement for generating recoil or hammer cocking according to another exemplary embodiment of the present invention.

### DETAILED DESCRIPTION

In the following description, for purposes of explanation and not limitation, specific details are set forth, such as device configurations in order to provide a thorough understanding of the present invention. It will be apparent to one skilled in the art that the present invention may be carried out in other embodiments that depart from these specific details.

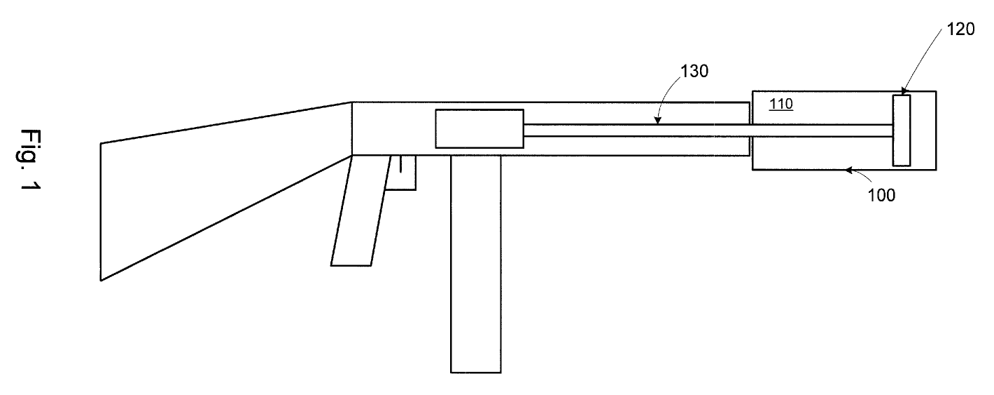

Referring to FIG. 1 there is illustrated a recoil generator arrangement 100 configured to generate a recoil or hammer cocking in a weapon comprising a barrel or barrel replica. The recoil generator arrangement 100 can be used on i.e. an A47 but the recoil generator arrangement 100 can also be used on several other types of weapons. The recoil generator arrangement 100 comprises a cylinder 110. The cylinder 100 is preferably made of metal but can also be made of different types of plastic materials or other materials. Further a piston 120 is movably arranged in the cylinder. The piston 120 is preferably made of metal but can also be made of different types of plastic materials or other materials. Yet further is an oblong element 130 arranged on the piston 120. The cylinder 110 is attachable on a front end of the weapon so that the oblong element 130 extends from the front end through the barrel or barrel replica to an element inside the weapon, and moves the element when the piston 120 is moved. In one exemplary embodiment of the recoil generator arrangement 100 according to the present invention is the element a bolt replica. The element can also be a bolt of the weapon or other part of the weapon.

In one exemplary embodiment of the recoil generator arrangement 100 according to the present invention is the piston 120 moved with compressed gas. In another exemplary embodiment of the recoil generator arrangement 100 according to the present invention is the piston 120 moved by electromagnetic means.

As mention before since the cylinder 110 is attachable on a front end of the weapon so that the oblong element 130 extends from the front end through the barrel or barrel replica to an element inside the weapon, the element is moved when the piston 120 is moved. By moving the element fast and so that the element is stopped by an inside part of the weapon a recoil or hammer cocking is created. The recoil or hammer cocking is thus created by the element hitting an inside part the weapon. The recoil or hammer cocking is thus created in a similar way as when the weapon is fired with sharp ammunition.

In one exemplary embodiment of the recoil generator arrangement 100 according to the present invention is the cylinder 110 removable attachable. In this exemplary embodiment can the cylinder 110 be removed after weapon training so that the weapon can be used with sharp ammunition. The cylinder 110 can be attachable on a silencer mount of the weapon, but cylinder 110 can also be mounted in other ways on the front end of the weapon.

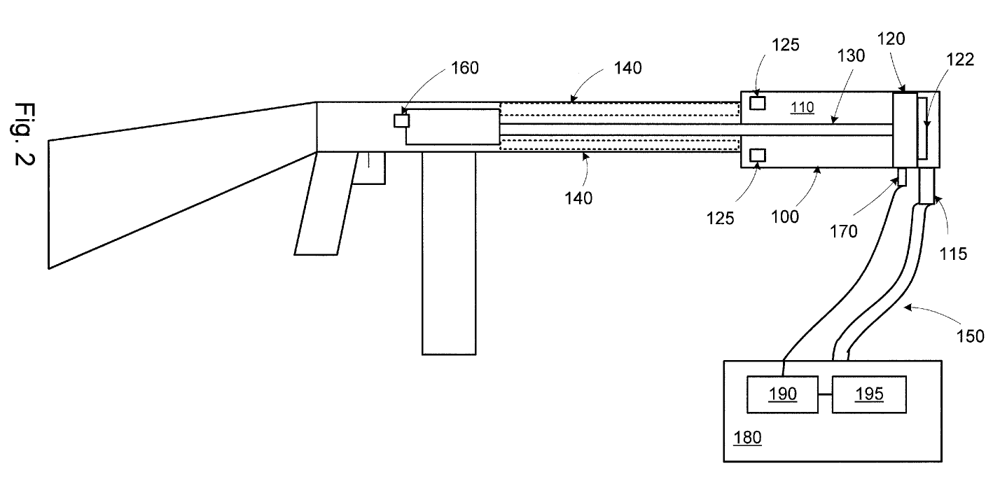

Referring to FIG. 2, the recoil generator arrangement 100 according to the present invention, where the piston 120 is moved with compressed gas, the cylinder 110 comprises an air inlet 115 on one side of the piston 120 and one or several holes 125 for letting out air on the opposite side. In this exemplary embodiment is a hose or a pipe 150 connected between the air inlet and a module 180 with compressed air supply (not shown) and a solenoid valve (not shown).

The piston 120 in the recoil generator arrangement 100 according to the present invention may comprise a shock absorbing material 122 on a front and/or a back end of the piston. The shock absorbing material absorbs the shock when the piston hits one or both ends of the cylinder 110.

In one exemplary embodiment of the recoil generator arrangement 100 according to the present invention is the oblong element 130 attached to the element. In other exemplary embodiments of the recoil generator arrangement 100 according to the present invention the oblong element 130 lies against the element. In the recoil generator arrangement 100 according to the present invention can the oblong element 130 be a rod or a pipe, but the oblong element can also be of other shapes. The oblong element 130 can also be a pipe with hydraulic or pneumatic medium.

The recoil generator arrangement 100 according to the present invention may comprising a protective pipe 140 arranged inside the barrel. The protective pipe 140 protects the barrel from the oblong element 130 so that the barrel does not become scratched when the oblong element 130 moves back and forth inside the barrel.

The recoil generator arrangement 100 can also comprise at least one sensor 160 for sensing the position of the element or a trigger of the weapon. The at least one sensor 160 can be a Hall sensor or other type of sensor capable of sensing an electromagnetic field change. The at least one sensor 160 can for instance be arranged to sense when the trigger is pulled and/or when the element reaches a specific position.

Further, the recoil generator arrangement 100 can in an exemplary embodiment comprise an electrical connection means 170. The electrical connection means can be used for connecting wires between the recoil generator arrangement 100 and a module 180 or another device. The module 180 further comprises communications means 190 for communicating with one or several of the sensors 160 via the electrical connection means 170. The module 180 can further comprise processing means 195 connected to the communications means 190 and configured to control the solenoid valve 155 so that compressed air is supplied to the cylinder 110 at the rights times in order to move the piston 120 in the cylinder 110.

Yet further, the recoil generator arrangement 100 can in another exemplary embodiment comprise a valve for controlling air supply to the cylinder, wherein the valve is controlled by a trigger of the weapon.

The detailed description is of the best mode presently contemplated for practicing the present invention. It is not intended to be taken in a limiting sense, but is made merely for the purpose of describing general principles. The scope of the invention is to be ascertained with reference to the issued claims.

1. A recoil generator arrangement (100) configured to generate a recoil or hammer cocking in a weapon comprising a barrel or barrel replica, said recoil generator arrangement comprising;
a cylinder (110);
a piston (120) movably arranged in said cylinder;
an oblong element (130) arranged on said piston;
characterized in that said cylinder (110) is attachable on a front end of said weapon so that said oblong element (130) extends from said front end through the barrel or barrel replica to an element inside the weapon, and moves said element when said piston is moved.

2. A recoil generator arrangement (100) according to claim 1, wherein said piston (120) is moved with compressed gas.

3. A recoil generator arrangement (100) according to claim 1, wherein said piston (120) is moved by electromagnetic means.

4. A recoil generator arrangement (100) according to claim 2, wherein said cylinder (110) comprises an air inlet (115) on one side of the piston (120) and one or several holes (125) for letting out air on the opposite side.

5. A recoil generator arrangement (100) according to any of claims 1 to 4, wherein said cylinder (110) is removable attachable.

6. A recoil generator arrangement according to any of claims 1 to 5, wherein said piston comprises a shock absorbing material (122) on a front and/or a back end of the piston.

7. A recoil generator arrangement (100) according to any of claims 1 to 9, wherein said oblong element (130) is attached to the element.

8. A recoil generator arrangement (100) according to any of claims 1 to 7, wherein said oblong element (130) is a rod.

9. A recoil generator arrangement (100) according to any of claims 1 to 7, wherein said oblong element (130) is a pipe with hydraulic or pneumatic medium.

10. A recoil generator arrangement (100) according to any of claims 1 to 9, wherein said cylinder (110) is attachable on a silencer mount of the weapon.

11. A recoil generator arrangement (100) according to any of claims 1 to 10, wherein the recoil generator arrangement (100) further comprising a protective pipe (140) arranged inside said barrel.

12. A recoil generator arrangement (100) according to any of claims 1 to 11, wherein said oblong element (130) is attached to said element.

13. A recoil generator arrangement (100) according to any of claims 1 to 12, wherein said element is a bolt replica.

14. A recoil generator arrangement (100) according to any of claims 1 to 13, wherein said element is a bolt of the weapon

15. A recoil generator arrangement (100) according to claim 4-14, wherein a hose or a pipe (150) is connected between said air inlet and a compressed air supply.

16. A recoil generator arrangement (100) according to any of claims 4-15, where a hose or a pipe (150) is connected between said air inlet and a module comprising a compressed air reservoir and a solenoid valve (155).

17. A recoil generator arrangement (100) according to any of claims 1 to 16, wherein said recoil generator arrangement (100) further comprising, at least one sensor (160) for sensing the position of the element or a trigger of the weapon.

18. A recoil generator arrangement 8100) according to claim 17, wherein said at least one sensor (160) is a Hall sensor.

19. A recoil generator arrangement (100) according to claim 18, wherein said recoil generator arrangement (100) further comprising electrical connection means (170) for connection wires between said recoil generator arrangement (100) and a module (180).

20. A recoil generator arrangement (100) according to claim 19, wherein said module (180) further comprising communications means (190) for communicating with one or several of the sensors (160) via said electrical connection means (170).

21. A recoil generator arrangement (100) according to claim 20, wherein said module (180) further comprising processing means (195) connected to said communications means and (190) configured to control said solenoid valve (155).

22. A recoil generator arrangement (100) according to any of claims 4 to 15, wherein said recoil generator arrangement (100) further comprises a valve for controlling air supply to the cylinder, wherein the valve is controlled by a trigger of the weapon.
